(19) United States
(12) Patent Application Publication
(10) Pub. No.: US 2025/0379843 A1
(43) Pub. Date: Dec. 11, 2025

(54) SECURE DECENTRALIZED SOCIAL MEDIA COMMUNICATION SYSTEM

(71) Applicant: Kingdom Partners LLC, Washington, WV (US)

(72) Inventor: William K. JONES, Washington, WV (US)

(73) Assignee: Kingdom Partners LLC, Washington, WY (US)

(21) Appl. No.: 19/040,659

(22) Filed: Jan. 29, 2025

Related U.S. Application Data
(60) Provisional application No. 63/626,433, filed on Jan. 29, 2024.

(51) Int. Cl. H04L 51/52; H04L 9/40; H04L 67/104

(52) U.S. Cl. CPC H04L 51/52; H04L 63/0428; H04L 67/104

(57) ABSTRACT

Provided is a method including nominating a prospective peer for addition to a group of peers communicating via a peer to peer communications system (P2PCS). The nominating includes an active peer within the group sending to the prospective peer, via the P2PCS, a nomination request using email as a primary transport mechanism. The nomination request includes an encrypted payload including instructions and the encryption is performed (i) via the P2PCS and (ii) responsive to a prearranged passphrase.

### CROSS REFERENCE TO RELATED APPLICATIONS

This application claims benefit to U.S. Provisional Patent Application 63/626,433 filed Jan. 29, 2024, the disclosure of which is incorporated herein in its entirety, by reference.

### FIELD OF TECHNOLOGY

The present disclosure relates generally to social media (SM) software communication systems. In particular, the present disclosure relates to a new implementation of SM designed to improve security between and among users via decentralization, obfuscation, and the special add-user process.

### BACKGROUND

Conventional SM communication platforms have become crucial to modern communication, allowing users to connect, share content, and interact with peers within an SM communication platform. These platforms present significant challenges related to privacy, data security, and user control. That is, content shared on the SM communication platforms is not private. Users often find themselves at the mercy of SM providers who control the content displayed, gather extensive personal data, and utilize centralized servers for data storage and processing. This centralized approach exposes user data to potential breaches, unauthorized access, and misuse by third parties.

The conventional SM communication platforms, however, primarily benefit providers rather than users. Providers control the content that users see, often prioritizing paid advertisements and sponsored posts over peer-generated content. This results in a user experience that is heavily influenced by commercial interests rather than genuine social interactions. Additionally, providers collect and analyze vast amounts of user data, including personal identifiable information (PII), which can be sold to third parties or used for targeted advertising. This data collection raises significant privacy concerns and exposes users to potential misuse of their information.

Centralized SM platforms also pose security risks. The reliance on central servers for data storage and processing makes these platforms attractive targets for hackers. Data breaches can result in the exposure of sensitive user information, leading to identity theft, financial loss, and other forms of exploitation. Furthermore, the storage of user data on these servers means that even old content remains vulnerable to unauthorized access. Users have limited control over their data, as providers often require broad permissions to use and distribute user-generated content.

### SUMMARY

Given the aforementioned deficiencies, what are needed are methods and systems to accomplish SM communication without the need for central servers for operation. What are also needed are systems and methods that can keep all content private within the peer groups of users who post it, while still providing basic functionality expected by SM users.

Under certain circumstances, an embodiment of the present disclosure includes a method including nominating a prospective peer in addition to a group of peers communicating on a peer-to-peer communications system. The nominating includes an active peer within the group sending to the prospective peer, via a peer-to-peer communications system (P2PCS), a nomination email having an encrypted payload including instructions. The encryption is performed (i) via the P2PCS and (ii) responsive to a prearranged passphrase. The method also includes accepting the nomination email at a nominee device instance associated with the prospective peer, returning, via the prospective peer, the prearranged passphrase to the nominee device instance, and sending, via the P2PCS at the nominee device instance, an acknowledgment packet responsive to the instructions.

Unlike traditional SM communication systems, such as those mentioned above that rely on centralized servers and data analytics, the embodiments leverage email as a primary transport mechanism, ensuring that user content remains private within peer groups. The embodiments offer several key advantages to the traditional SM communication platforms.

For example, one or more embodiments of the present disclosure provide decentralized communication with an ability to operate without the need for consistent central servers, using standard email servers that can be changed at will by users. This reduces the risk of data breaches and unauthorized access.

The present disclosure also provides peer-specific encryption and obfuscation. Since email may traverse public networks, the present disclosure also provides peer-specific encryption and obfuscation. That is, the embodiments employ robust encryption and obfuscation methods specific to peer groups, making it difficult for automated surveillance and decryption by third parties. A unique onboarding process ensures that only desired peers become part of the peer group, preventing unsolicited content from vendors or advertisers. As described herein, users have complete control over the content they see and share, with options to filter out unwanted messages, keywords, or content types.

Embodiments of the present disclosure also provide an alternative transmission medium. That is, the system allows for the use of transmission media other than email, such as a distributed network of servers, providing flexibility and enhanced security. The P2PCS constructed in accordance with the embodiments also does not track user data or perform data analytics, ensuring that user information is not sold to third parties or used for purposes inconsistent with user interests.

The above-mentioned features collectively provide a secure, user-centric P2PCS that addresses the deficiencies of existing solutions, offering enhanced privacy, security, and control over user content.

According to another aspect of the present disclosure, a system for secure communications may include a computer controller or central processing unit (CPU) configured to run algorithms that execute the secure communications process, a graphical user interface (GUI); an input device; an output device; at least one data storage device; a communications device; and an internet connection.

In yet another embodiment of the present disclosure, a communication software device comprises user presentation of a formatted listing of individual messages from one or more peers; a mechanism for the creation, processing, storage, and removal of the messages; a mechanism for adding and removing peers for message interchange; transmission of messages between peers via standard email servers using a format determined by algorithm and user-defined parameters; a mechanism for choosing the email account or accounts used to transport messages according to algorithm and user-defined parameters; a mechanism for avoiding message duplication; a mechanism for ensuring that only intended peers are included in messaging; a mechanism for retransmission of messages to new or existing peers; a mechanism for limiting message size and content types per user preference; a mechanism for users to specifically approve or highlight messages (feedback) and communicate these actions to peers; a mechanism for creating a new device instance; and a mechanism for adjusting transmission content and behavior based on email provider-specific anti-spam constraints.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to people skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a conventional SM platform.

FIG. 2 illustrates an exemplary P2PCS platform constructed and arranged in accordance with one or more embodiments of the present disclosure.

FIG. 3 illustrates a more detailed block diagram of the exemplary P2PCS depicted in FIG. 2.

FIG. 4 illustrates a process flow diagram of a method of implementing an onboarding process in accordance with a first embodiment of the present disclosure.

FIG. 5 is an exemplary swimlane diagram illustrating interaction between the nominator and the nominee during the onboarding process depicted in FIG. 4.

FIG. 6 is a block diagram of an exemplary computing device configured for implementing one or more embodiments of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

This document describes the working details of a software communications device. The purpose of this device is to provide an alternative to all of the other intrusive SM options that currently flood the marketplace. This device is different from all other SM options in that it keeps all content private within the peer groups of users who post it, while still providing all of the same functionality users would expect. This device makes this possible by leveraging a unique combination of methods and existing technology: a special peer onboarding process, peer message encryption and obfuscation, and the use of a ubiquitous transport mechanism: email. In an exemplary embodiment, the use of email as a transport medium for SM functionality and communication may be employed in a manner independent from the other features of the disclosed P2PCS.

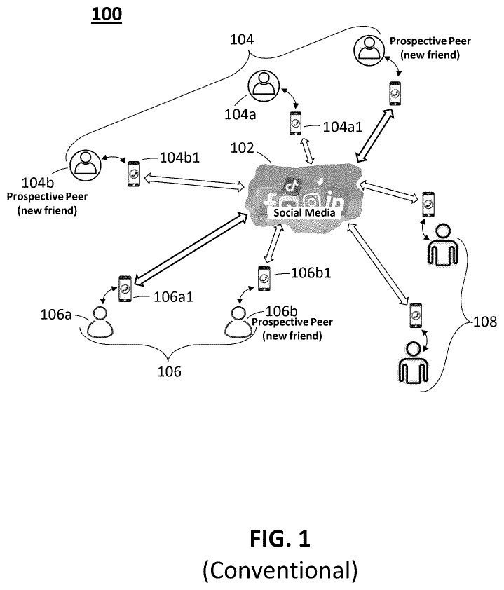

FIG. 1 illustrates a conventional SM platform 100 including an SM application 102, such as Facebook, LinkedIn, Instagram, etc. During operation, the SM platform 100 includes user groups (i.e., peer groups) 104, 106, 108. The peer groups 104-108 may be referred to as friends or connections in one or more SM applications 102. Active peers within the peer groups 104-108, such as active peers 104a, 104b, 104c of the peer group 104, view content, share content, and interact with each other through various devices, or device instances. By way of example only, and not limitation, peers 104a-104b and 106a-106b may respectively use mobile phone devices 104a1-104b1 and 106a1-106b1 to interface with the SM platform 100 and to host the SM application 102.

In FIG. 1, the active peer 106a may desire to add a new (i.e., prospective) peer to the peer group 106. Specifically, the active peer 106a may desire to add prospective peer 106b, who may already be a subscriber to the SM platform application 102. Accordingly, to nominate the prospective peer 106b for membership within the peer group 106, the active peer 106a will send the prospective peer 106b a nomination request (e.g., a friend request).

Once the prospective peer 106b accepts the nomination request, the prospective peer 106b will become an active peer within the peer group 106. As a newly active peer within the peer group 106, the peer 106b will be able to view content, share content, and interact with other active peers within the peer group 106, such as the active peer 106a.

As explained above, however, all active members of conventional SM platforms, such as the conventional SM platform 100, will become subject to the aforementioned challenges related to privacy, data security, and user control. The new active peers will be at the mercy of SM providers who can control their displayed content and have their personal data gathered and analyzed. Additionally, the conventional SM platform 100 utilizes centralized servers for data storage and processing, exposing the user data of each of the peers within the peer groups 104-108 to potential data breaches, unauthorized access, and misuse by third parties.

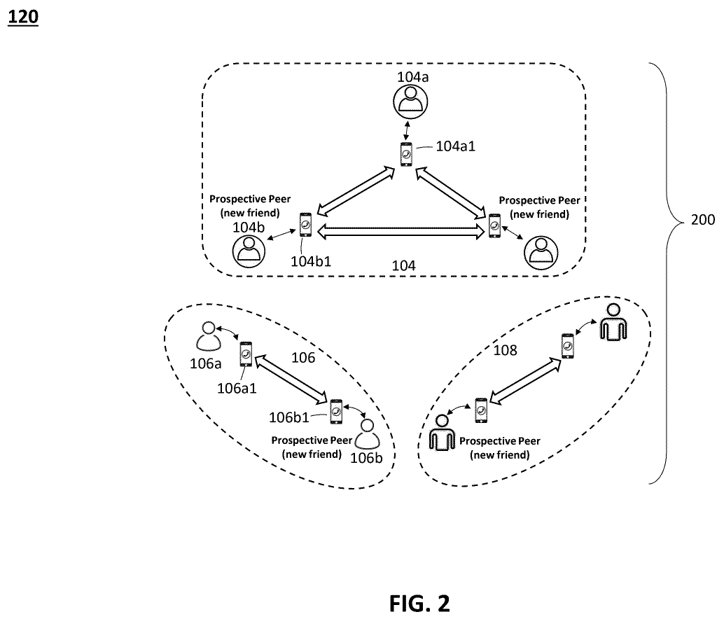

FIG. 2 illustrates an exemplary SM platform 120 and P2PCS application 200, constructed and arranged in accordance with one or more embodiments of the present disclosure. In the P2PCS application 200, all peer groups communicate only with other peers via email (or alternately through a computer network that includes servers using an alternate protocol). In this manner, the P2PCS 120 does not need a central server for operation.

As illustrated in the example of FIG. 1, peers 104a-104b and 106a-106b may respectively use mobile phone devices (or device instances) 104a1-104b1 and 106a1-106b1 to interface with the SM platform 120 and to host the P2PCS application 200.

As used herein, the term device instance means a logical representation of a physical device, such as a mobile phone, tablet, personal computer (PC) etc. The device instance 104a1 may also be a software application (app). In the embodiments, the device or app instance includes every running app installation occurring within a peer group, such as the peer group 106. The device instance 106a1 may initiate the process of nominating a prospective peer for inclusion in the peer group 106. The P2PCS application 200 implements the activities and operations initiated by the device instance 106a1.

This direct peer to peer communication provided in the P2PCS application 200, using email (one of the most ubiquitous communication methods available) as the primary transport mechanism, ensures that user content remains private within peer groups and that personal data remains personal. In other words, the personal data of the members of a peer group is kept exclusively within the peer group.

For simplicity, the P2PCS application 200 will be described using the peer groups 104-108 depicted in FIG. 1. As noted above, the P2PCS application 200 relies on email, or similar packet-based communication, as the primary transport, or communications, mechanism between peers within the peer groups 104-108. As one way to prevent surveillance, emails as used herein are implemented using encryption and obfuscation parameters as described in greater detail below.

In describing the exemplary operation of the P2PCS application 200, consider the example of FIG. 1 above where the active peer 106a desires to add a new peer (106b) to the peer group 106.

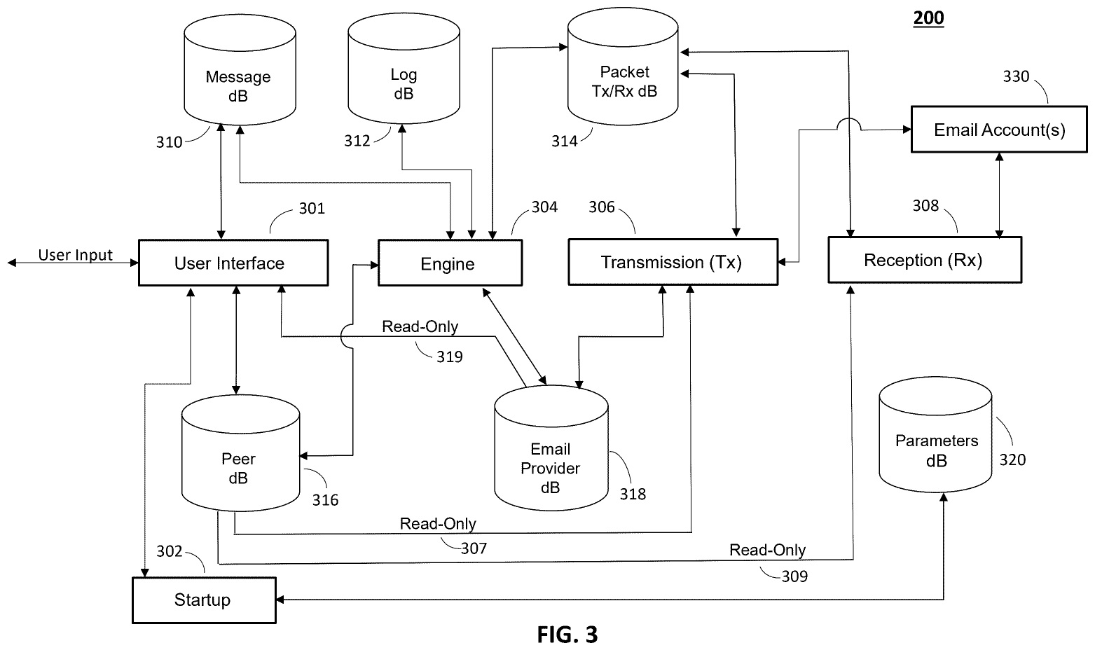

In the exemplary P2PCS application 200, to nominate the prospective peer 106b for membership within the peer group 106, the active peer 106a will first need an email address (e.g., gmail.com, yahoo.com, outlook.com, etc.) for the prospective peer 106b. The email address may be a previously identified (e.g., personal, work etc.) email address. Using this email address, or other means of communication, the active peer 106a will directly communicate, via the device 106a1, with the prospective peer 106b to initiate an encrypted process (described in greater detail below with reference to FIGS. 3-5) for onboarding to the P2PCS application 200.

As an initial step in this process, the active peer 106a and the prospective peer 106b may agree upon a password for use during onboarding. As described later, the password is used to facilitate exchange of an encrypted package between the active peer 106a and the prospective peer 106b during the onboarding process. The onboarding process is a means (a negotiation) through which the identity of the peers is authenticated. After the nomination process has been completed and peer 106b, via use of the device 106b1, becomes an active peer, the active peers within the peer group 106 (e.g., peers 106a and 106b) will be able to share content directly between themselves using specially encrypted email communication paths. Communication and sharing content within the SM platform 200 may have the same “end-user” look and feel as the conventional SM platform 100. For example, the use of email, or packet-communication systems, will be transparent to the peers or users of the P2PCS application 200.

FIG. 3 illustrates a more detailed block diagram of the exemplary P2PCS application 200 depicted in FIG. 2. The P2PCS application 200 includes a user interface (UI) 301, a startup processor 302, a computational engine 304, a transmission (Tx) component (e.g., transmitter) 306, and a reception (Rx) component (e.g., transmitter) 308. The UI 301, the startup processor 302, the engine 304, the transmitter 306, and the receiver 308 are respectively coupled to a plurality of databases. The transmitter 306 and the receiver 308 are coupled to user email accounts 330. Each of the databases is configured to store specific data associated with a separate aspect of the P2PCS application 200, as described below.

The UI 301 is the primary point of interaction between the user and the P2PCS application 200. The UI 301 receives input from the user, such as email addresses and passphrases for new peers, and displays outputs, including the status of peer nominations and received messages. The UI 301 is coupled to the startup processor 302 and interacts with peer dB (dB) 316 to create new peer records and update existing ones based on user actions. The UI 301 also interacts with message dB 310, as explained below.

As used herein, and as understood by a person of ordinary skill in the art, a passphrase may be a sequence of words or other text used to provide secure access to a computer controller or system. Within the embodiments, the passphrase is used to ensure the identity of a potential peer. The passphrase is communicated between the peers and agreed upon via some method outside the device (e.g., verbal, text message, etc.). The passphrase may be defined at startup but can be entered during peer nomination for a peer-specific nomination process.

The UI 301 also reflects the status of nominations sent and received acknowledgments, ensuring that users are informed of the current state of their peer relationships. The UI 301 also allows users to compose new messages, select peers for communication, and view received messages, providing a comprehensive interface for managing social media interactions. The UI 301 enables a user to interact with the startup processor 302.

The startup processor 302 is a component of the device instance that executes the instructions described above and below. By way of example, the “create database” statements in the code may be located within the startup processor 302. The startup processor 302 is also responsible for initializing the decentralized P2PCS application 200, initializing all databases, and invoking the user interface 301. During the creation of a new device instance, the startup processor 302 initializes all dBs, including the peer dB 316, message dB 310, packet dB 314, parameters dB 320, email provider dB 322, and log dB 324.

The startup processor 302 populates the parameters dB 320 with device default values and pre-populates the email provider dB 318 with known popular email provider information. The startup processor 302 prompts the user for necessary information, such as personal details, email accounts to be used by the device, and a peer passphrase for the peer nomination process. The startup processor 302 also calls the receiver 308 to perform an initial review of emails in the email account(s), looking for existing nomination emails intended for the device.

Computational engine 304 is the processing unit of the decentralized P2PCS application 200. The computational engine 304 handles processing tasks related to the creation, processing, storage, and removal of messages. The computational engine 304 evaluates new transactions occurring within the peer dB 316, the packet dB 314, and the message dB 318 and responds accordingly. The computational engine 304 generates nomination packets, processes decrypted payloads and creates acknowledgment packets.

As used herein, the term packet refers to the basic unit of information being transmitted to one or more peers. In the preferred embodiments, this basic unit of information may be a single email. Single messages may be divided into multiple packets. A packet can contain one or more of the following: message, parameter, and message feedback.

The computational engine 304 also evaluates acknowledgment responses and creates peer parameter packets, ensuring that communications between peers are secure and authenticated. The computational engine 304 is communicatively coupled to the message dB 310, the log dB 312, the packet Tx/Rx dB 314, the peer dB 316, and email provider dB 318.

transmitter 306 is responsible for sending packets to peers within the decentralized P2PCS application 200. The transmitter 306 retrieves packets from the packet dB 314, formats them in accordance with suitable protocols, such as the simple mail transfer protocol (SMTP), and sends them to the user's server. By way of example only, and not limitation, the user's server may be an SMTP server.

The transmitter 306 updates the packet dB 314 with the outcome of the transmission, including any server responses. The transmitter 306 also ensures that all nomination emails, acknowledgment emails, and peer parameter emails are transmitted securely and efficiently. The transmitter 306 interacts, at least indirectly, with the computational engine 304 to receive packets flagged for transmission and with the email provider dB 318 to ensure compliance with provider constraints.

The receiver 308 is responsible for receiving packets from peers within the decentralized P2PCS application 200. The receiver 308 monitors the designated email accounts for new emails, evaluates the subject prefix to determine if the email is intended for the device, and creates new packet records in the packet dB 314. The receiver 308 processes the decrypted payloads, extracts onboarding instructions, and verifies the integrity of the messages. The receiver 308 also ensures that all received nomination emails, acknowledgment emails, and peer parameter emails are processed securely and efficiently. The receiver 308 interacts, at least indirectly, with the computational engine 304 to process received packets and with the email provider dB 318 to manage email reception securely.

The peer dB 316 interacts with the transmitter 306 along read-only communications path 307 and with receiver 308 along read-only communications path 309. The peer dB 316 stores all information related to peers within the decentralized P2PCS application 200. The peer dB 316 includes fields such as peer identification (ID), email addresses, email provider, passphrase, nomination date, status, active nominator, active nominee, obfuscation map, and nomination packet ID. The peer dB 316 ensures that all peer-related information is stored and retrieved efficiently, allowing the device to manage peer nominations, acknowledgments, and communications securely. The peer dB 316 interacts with the UI 301 to create and update peer records based on user actions and with the computational engine 304 to process peer-related transactions.

The message dB 318 stores all message content within the P2PCS application 200. The message dB 318 interacts with the computational engine 304 to process message-related transactions and with the UI 301 to display message content to the user. The message dB 318 also ensures that all message-related information is stored and retrieved efficiently, allowing the device to manage the creation, processing, storage, and removal of messages securely. The message dB 318 may include data storage fields such as message number, message ID, message media type, recipient peer IDs, creator peer ID, creator device instance ID, public or private status, feedback, thread ID, thread sequence, and transmission response.

By way of example only, and not limitation, the feedback field may be structured to match recipient peer IDs so that it can be parsed properly (first feedback is for the first peer, second feedback is for the second peer, etc.). The thread ID may be a long Guid generated by the device where the message was created. If empty, this is a new message which effectively starts a new thread. The message ID of the original message is the thread ID.

The packet dB 314 stores all packets to be transmitted and received within the decentralized P2PCS application 200. The packet dB 314 includes fields such as packet number, packet type, transmission release time, retransmission release time, transmission response, packet map, obfuscation map, packet header, packet subject, packet body, and packet attachment text. The packet dB 314 ensures that all packet-related information is stored and retrieved efficiently, allowing the device to manage the transmission and reception of packets securely. The packet dB 314 interacts with the transmitter 306 to manage packet transmission and with the receiver 308 to manage packet reception.

The parameters dB 320 (referenced by all components) stores device parameters, including obfuscation methods, within the decentralized P2PCS application 200. The parameters dB 320 may include data storage fields such as device instance ID, user peer ID, starting message Guid, encryption and obfuscation parameters, email accounts, message options, UI options, transmission options, global peer-group parameters, peer-specific parameters, global obfuscation options, global purge options, and logging options. The parameters dB 320 ensures that parameter-related information is stored and retrieved efficiently, allowing the device to manage configuration and operation securely. The parameters dB 320 interacts with the startup processor 302 to initialize device parameters and with the computational engine 304 to apply these parameters during operation.

Embodiments of the present disclosure provide peer-specific and peer-group-specific encryption and obfuscation. By way of example, some forms of artificial Intelligence (AI) can present vulnerabilities to the security and privacy of traditional interpersonal communication, particularly when this communication occurs in “private” social media or email contexts. The P2PCS application 200 offers a strong defense against AI related security vulnerabilities by employing both encryption and obfuscation methods that are unique to each peer group. All data at rest and in transit outside a device instance—including data appearing in email—is protected by these methods.

Additionally, encryption and obfuscation as described herein, are unique for each individual peer-group and can be employed in a manner independent from the other features of the P2PCS application 200.

Furthermore, the P2PCS application 200 allows for the use of AI to assist in the encryption and obfuscation process, thereby providing an even more hardened defense against any kind of automated surveillance. That is, the exemplary the P2PCS application 200 architecture allows for the inclusion of an AI security plug-in. This plug-in, for example, is capable of using both specialized encryption and multiple email accounts to distribute message content. This adds another layer of defense against surveillance by any adversary which may be equipped with AI.

In other words, the P2PCS application 200 provides a next-level SM environment needed to meet the security and privacy demands of a new generation of users whose digital lives will be constantly impacted by AI.

The email provider dB 318 stores information about email providers within the decentralized P2PCS application 200. The email provider dB 318 is coupled to the computational engine 304 and the transmitter 306. The email provider dB 318 is also coupled to the UI 301 along read-only communications path 319.

The email provider dB 318 includes constraints for each email account known to the device instance, including that of the device user and the email accounts of peers. The email provider dB 318 is read and updated by the transmitter 306 and the computational engine 304 to indicate current status of the email provider. The email provider dB 318 is pre-loaded with known email providers (such as Gmail, IONOS, etc.) and their constraints, identifiable by the email server hostnames they publish in public domain name system (DNS) records.

By way of example only, and not limitation, the email provider dB 318 may include data storage fields such as provider ID, provider name, per-day transmission limit, total number of transmissions this day, and first day transmission date. Additional fields may include per-hour transmission limit, total number of transmissions within hour, first hour transmission date, size limit, recipient count limit, recipient count time frame, total number of recipients transmitted within the time frame, first recipient transmission date, last successful transmission date, last failed transmission date, last failed transmission reason, next transmission allowed date and known email server hostname list.

The email provider dB 318 ensures that all email provider-related information is stored and retrieved efficiently, allowing the device to manage email transmissions securely and in compliance with provider constraints. The email provider dB 318 also interacts with the transmitter 306 and the receiver 308 to manage email provider constraints during transmission and reception.

Log dB 312 stores device activity provided by the components within the decentralized P2PCS application 200 and is where all components record all errors and selected actions. The log dB 312 may include data storage fields such as log entry ID, timestamp, component name, activity description, and activity outcome. The log dB 312 ensures that log-related information is stored and retrieved efficiently, allowing the device to maintain a detailed record of operations for debugging and auditing purposes. The log dB 312 interacts with all components within the P2PCS application 200 to record their activities and with the computational engine 304 to process and store log entries.

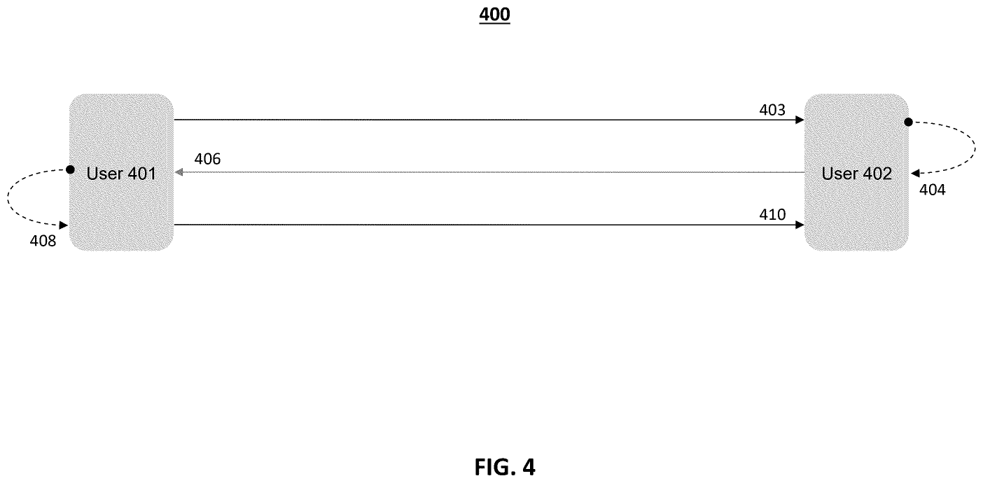

FIG. 4 shows a process flow diagram 400 of a method of implementing an onboarding process in accordance with a first embodiment of the present disclosure. The diagram 400 illustrates the communication steps (between a user 401 and a user 402) during the peer nomination and acceptance process.

In block 403, the user 401 initiates the process by sending a nomination email to user 402. This email contains a payload encrypted using a local passphrase agreed upon by both users.

In block 404, user 402 receives the nomination email. user 402 then decrypts the payload using the local passphrase and sends an acknowledgment email back to user 401, confirming the receipt and acceptance of the nomination. In block 406, user 401 receives the acknowledgment email from user 402. User 401 evaluates the response to ensure the response meets the expected criteria. If the response is valid, user 401 accepts user 402 as a peer.

In block 408, user 401 sends a peer parameter email to user 402. This email contains the parameters that define all future communications between user 401 and user 402, encrypted using the same passphrase or obfuscation method employed in the initial nomination email.

In block 410, user 402 receives the peer parameter email. user 402 decrypts the email using the same passphrase and updates the communication parameters accordingly. At this point, both users are successfully onboarded as peers and can securely communicate using the defined parameters. The process illustrated in FIG. 4 ensures that the communication between the user 401 and the user 402 is secure, authenticated, and resilient to potential errors, providing a robust method for onboarding new peers in the secure decentralized social media communication system. The unique peer onboarding method described in the flow diagram 400 can be employed in a manner independent from the other features of the P2PCS application 200.

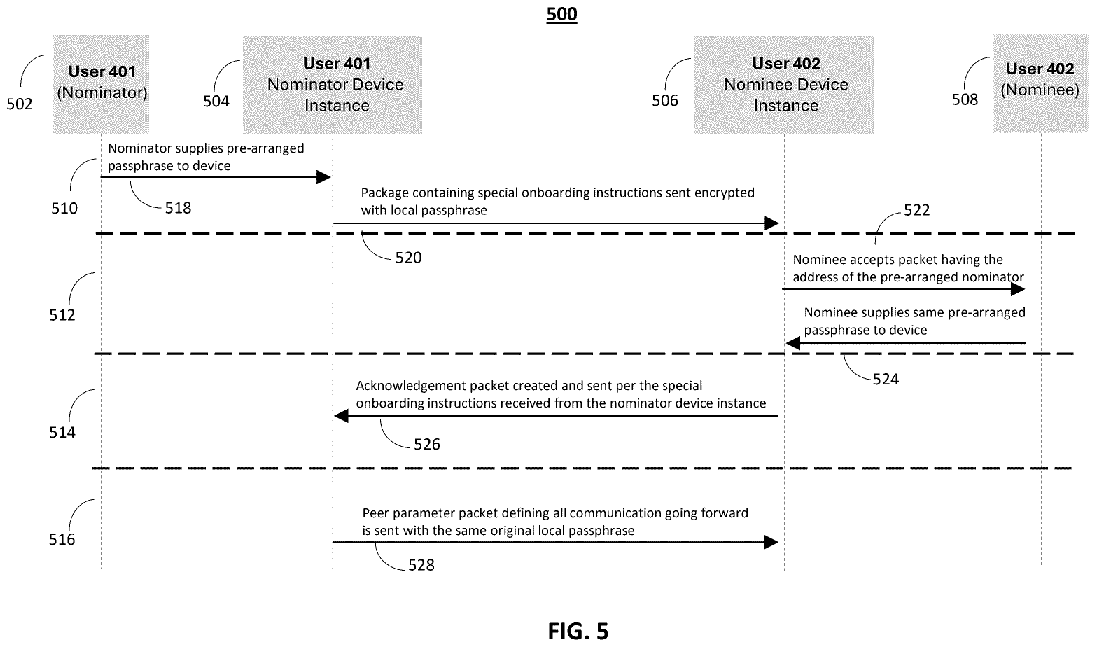

FIG. 5 illustrates a swimlane diagram 500 describing interaction between the nominator and the nominee depicted in FIG. 4. The diagram 500 delineates the actions required from both the nominator and the nominee, as well as their respective device instances. In FIG. 5 (e.g., a first operational stage: phase-1, 510), the user 401, acting as nominator 502, supplies a pre-arranged passphrase to a nominator device instance, such as nominator device instance 504. This action is represented by the arrow 518.

In FIG. 5, the nominator device instance 504 is responsible for sending the initial nomination email that includes an encrypted payload and processing the acknowledgment, and peer parameter messages, to establish secure communication with a nominated peer (e.g., a nominee). The nominator device instance 504 sends a packet containing onboarding instructions encrypted with the local passphrase to a nominee device instance 506, as indicated by arrow 520.

During a second operational stage (e.g., phase-2, 512), the user 402, acting as nominee 508, accepts the nomination email containing the onboarding instructions at arrow 522, which includes the email address of the nominator 502, and a pre-arranged passphrase. The nominee 508 supplies the same pre-arranged passphrase to the nominee device instance 506, as shown by arrow 524.

During a third operational stage (e.g., phase-3, 514), the nominee device instance 506 creates and sends an acknowledgment packet per the onboarding instructions received from the nominator device instance 504, as indicated by arrow 526.

During a fourth operational stage (e.g., phase-4, 516), The nominator device instance 504 sends a peer parameter packet defining communication going forward, encrypted with the same original local passphrase, to the nominee device instance 506. This action is represented by the arrow 528. This completes the nomination process, establishing a secure communication channel between the user 401 and the user 402.

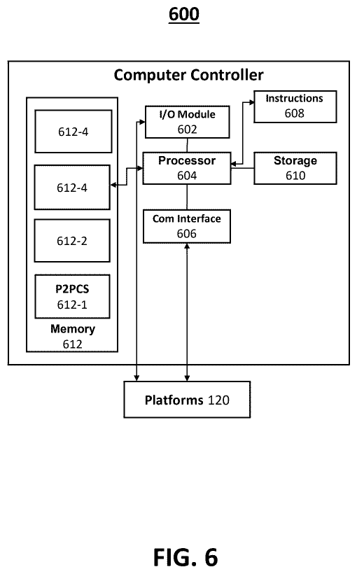

FIG. 6 illustrates a computer controller 600 that may be an application-specific hardware, software, and firmware implementation of the P2PCS application 200 depicted in FIGS. 2-5, described above. The controller 600 may include a processor 604 configured to be executed on one or more, or all the blocks of the system of FIGS. 2-5, described above.

The processor 604 can have a specific structure imparted to the processor 604 by instructions stored in the memory 612 and/or by instructions 608 fetchable by the processor 604 from a storage medium 610. The storage medium 610 can be remote and communicatively coupled to the controller 600.

The controller 600 can be a stand-alone programmable system, or a programmable module included in a larger system. For example, the controller 600 may include or be connected with the P2PCS application 200. For example, the controller 600 may include one or more hardware and/or software components configured to fetch, decode, execute, store, analyze, distribute, evaluate, and/or categorize information.

The processor 604 may include one or more processing devices or cores (not shown). In some embodiments, the processor 604 may be a plurality of processors, each having one or more cores. The processor 604, in another embodiment, may be a distributed processor. The processor 604 can execute instructions fetched from the memory 612, i.e., with reference to, among other code, instructions or data, one of memory modules 612-1, 612-2, 612-3, or 612-4. Alternatively, the instructions can be fetched from the storage medium 610, or from a remote device connected to the controller 600 via the communication interface 606.

Furthermore, the communication interface 606 can also interface with processors within a computer system of the P2PCS application 200. An input/output (I/O) module 602 may be configured for additional communications to or from associated local and/or remote systems of one or more platforms, such as the P2PCS application 200 of FIG. 2.

Without loss of generality, the storage medium 610 and/or the memory 612 can include a volatile or non-volatile, magnetic, semiconductor, tape, optical, removable, non-removable, read-only, random-access, or any type of non-transitory computer-readable computer medium. The storage medium 610 and/or the memory 612 may include programs and/or other information usable by processor 604. Furthermore, the storage medium 610 can be configured to log data processed, recorded, or collected during the operation of the controller 600.

The data may be time-stamped, location-stamped, cataloged, indexed, encrypted, and/or organized in a variety of ways consistent with data storage practice. The memory modules in memory 612 may represent specialized modules for various functions described in the embodiments herein.

By way of example, the memory module 612-1 may represent a specialized module configured to implement aspects of encryption and passphrase creation process described above. Similarly, the memory module 612-2 may form a specialized nominee application or device instance module, the memory module 612-3 may form a specialized nominator application or device instance module, and the memory module 612-4 may form a specialized nomination process module, as described with reference to one or more of FIGS. 2-5, described above. The instructions embodied in these memory modules can cause the processor 604 to perform certain operations consistent with the functions described above.

The processor 604 is a hardware device for executing software, particularly stored in memory 612. The processor 604 can be any custom made or commercially available processor, a CPU, an auxiliary processor among several processors associated with the computer controller 600, a semiconductor based microprocessor (in the form of a microchip or chip set), a macroprocessor, or generally any device for executing software instructions.

Moreover, the memory 612 may incorporate electronic, magnetic, optical, and/or other types of storage media. Note that the memory 612 can have a distributed architecture, where various components are situated remote from one another, but can be accessed by the processor 604.

The memory 612 can include any one or combination of volatile memory elements (e.g., random access memory (RAM, such as DRAM, SRAM, SDRAM, etc.)) and nonvolatile memory elements (e.g., ROM, erasable programmable read-only memory (EPROM), electronically erasable programmable read-only memory (EEPROM), programmable read-only memory (PROM)).

Memory 612 may also include removable storage such as tape, compact disc read-only memory (CD-ROM), disk, diskette, cartridge, cassette or the like, etc., and non-removable storage such as a hard disk drive (HDD).

Moreover, the memory 612 may incorporate electronic, magnetic, optical, and/or other types of storage media. Note that the memory 612 can have a distributed architecture, where various components are situated remote from one another, but can be accessed by the processor 604.

The software in memory 612 may include one or more separate programs, each of which comprises an ordered listing of executable instructions for implementing logical functions, and a suitable operating system (OS). The OS essentially controls the execution of the computer programs, and provides scheduling, input-output control, file and data management, memory management, and communication control, and related services.

If the computer controller 600 is a PC, workstation, intelligent device or the like, the software in the memory 612 may further include a basic I/O system (BIOS), omitted from this description for simplicity. The BIOS is a set of essential software routines that initialize and test hardware at startup, start the OS, and support the transfer of data among the hardware devices. The BIOS is stored in read-only memory (ROM) so that the BIOS can be executed when the computer controller 600 is activated.

An alternative embodiment avoids the problems of inadequate or limited device resources by utilizing cloud computing in a specialized manner. In this alternative embodiment, the P2PCS application 200 operates as usual, but the user device instances act as a client to the storage, computing, and communications functions performed on one or more dedicated cloud servers. Unlike current SM offerings, however, all data processed by those servers is encrypted and unreadable to them. That is, the cloud servers have no access to the actual content of the messages being processed.

This alternative embodiment follows a model used by software products such as LASTPASS and IDRIVE. These products encrypt data to the client before it ever reaches a cloud server without storing encryption keys. Since only the user knows the encryption key, only the user is capable of decrypting the data and revealing its content.

This alternative embodiment also allows for an alternate transport mechanism where packets can be sent without the use of email. While the cloud servers could distribute packets via email to those peers that require it, central servers can also function as direct relays between peer device instances and thus avoid the overhead of email communication altogether.

Embodiments may be provided as a computer program product including a non-transitory computer and/or monitored machine-readable medium having stored thereon instructions that may be used to program a computer (or other electronic device) to perform processes described herein. For example, a non-transitory computer-readable medium may store instructions that, when executed by a processor of a computer system, cause the processor to perform certain methods disclosed herein.

Further, in an exemplary embodiment, communication via network may be facilitated by networking devices including, but not limited to, multiplexers, routers, hubs, gateways, firewalls, and switches. In some embodiments, intelligent devices and network devices may comprise physically distinct devices. In other embodiments, intelligent devices and network devices may be composite devices, or may be configured in a variety of ways to perform overlapping functions. Intelligent devices and network devices may comprise multi-function hardware (e.g., processors, computer-readable storage media, communications interfaces, etc.) that can be utilized to perform a variety of tasks that pertain to network communications and/or to operation of equipment within a system.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded with the broadest scope consistent with the principles and novel features disclosed herein.

What is claimed is:

1. A social media communications system configured to facilitate content sharing and communication between two or more peers, wherein email is used as a primary transport mechanism for the communication and content.

2. The social media communications system of claim 1, wherein the two or more peers form a peer group.

3. The social media communications system of claims 2, further comprising a secure communications mechanism unique to the peer group.

4. A method comprising:
nominating a prospective peer for addition to a group of peers communicating via a peer to peer communications system (P2PCS);
wherein the nominating includes an active peer within the group sending to the prospective peer, via the P2PCS, a nomination request using email as a primary transport mechanism;
wherein the nomination request includes an encrypted payload including instructions; and
wherein the encryption is performed (i) via the P2PCS and (ii) responsive to a prearranged passphrase.

5. The method of claim 4, further comprising:
accepting the nomination email at a nominee device instance associated with the prospective peer;
returning, via the prospective peer, the prearranged passphrase to the nominee device instance; and
sending, via the P2PCS at the nominee device instance, an acknowledgment packet responsive to the instructions.

6. The method of claim 4, further comprising accepting the prospective peer if the acknowledgment packet contains a proper response.

7. The method of claim 4, wherein the nominating occurs via a nominating device instance or a nominating application instance.

8. The method of claim 4, wherein the P2PCS includes a computational engine communicatively coupled to dedicated databases.

9. The method of claim 4, wherein each of the peer nomination databases is configured to store specific data associated with each component of the P2PCS.

10. The method of claim 5, wherein the dedicated databases include a message database (dB), a packet transmit/receive dB, a peer dB, and an email provider dB.

11. The method of claim 5, wherein the method provides secure communication within the group of users.

12. The method of claim 11, wherein the proper response includes specific content unique to the onboarding transaction.

13. The method of claim 11, further comprising sending a peer parameter packet, via the nominator device instance, when the acknowledgment packet contains a proper response.

14. The method of claim 5, wherein the peer parameter message is decrypted using the obfuscation employed in the nomination message.

15. A non-transitory computer readable medium having stored thereon computer executable instructions that, if executed by a computing device, cause the computing device to perform a method for use by a memory controller of a peer-to-peer communications system (P2PCS), the method comprising:
nominating a prospective peer for addition to a group of peers communicating via a peer to peer communications system (P2PCS);
wherein the nominating includes an active peer within the group sending to the prospective peer, via the P2PCS, a nomination request using email as a primary transport mechanism;
wherein the nomination request includes an encrypted payload including instructions; and
wherein the encryption is performed (i) via the P2PCS and (ii) responsive to a prearranged passphrase.

16. The non-transitory computer readable medium of claim 15, further comprising: accepting the nomination email at a nominee device instance associated with the prospective peer;
returning, via the prospective peer, the prearranged passphrase to the nominee device instance; and
sending, via the P2PCS at the nominee device instance, an acknowledgment packet responsive to the instructions.

17. The non-transitory computer readable medium of claim 15, further comprising accepting the prospective peer if the acknowledgment packet contains a proper response.

18. The non-transitory computer readable medium of claim 15, wherein the nominating occurs via a nominating device instance or a nominating application instance.

19. The non-transitory computer readable medium of claim 15, wherein the P2PCS includes a computational engine communicatively coupled to dedicated databases.

20. The non-transitory computer readable medium of claim 19, wherein each of the databases is configured to store specific data associated with each component of the P2PCS.
